(19) United States
(12) Patent Application Publication
(10) Pub. No.: US 2010/0112517 A1
(43) Pub. Date: May 6, 2010

(54) DRILL FOR RAPID DENTAL IMPLANT

(76) Inventor: Chu-Leon CHEN, Changhua City (TW)

Correspondence Address: Guice Patents PLLC, 12647 Galveston Court #302, Manassas, VA, 20112, US

(21) Appl. No.: 12/265,854

(22) Filed: Nov. 6, 2008

(51) Int. Cl. A61C 3/02

(52) U.S. Cl. 433/165

(57) ABSTRACT

A drill for dental implant is disclosed to include a connection head configured for quick connection to a dental handpiece, a round bur, and a series of active drill body portions of different diameters connected between the connection head and the round bur, said active drill body portions in an order from the smallest diameter to the largest diameter in direction from the round bur toward the connection head.

### BACKGROUND OF THE INVENTION

1. Field of the Invention

The present invention relates to a drill dental implant and more particularly, to a high-efficient drill for drilling a hole on a crestal bone efficiently at a time for direct tapping.

2. Description of the Related Art

During dental implant placement, osteotomy is performed to make a proper size round hole on the crestal bone for the installation of an implant.

During osteotomy, drills are used to drill a cut hole. According to conventional designs, different sizes of drills, as shown in FIG. 1 A˜J, are used to finish the drilling operation. In FIG. 1, the component referenced by A is a round bur for flattening the occlusal surface of the crestal bone 10 and making a location mark for implant; the components referenced by B, C, E, F, G and H are drills of different diameters for drilling a cut hole smaller than the diameter of the implant (for example, if the diameter of the implant is 4.75 mm, the diameter of the drill H is 4.25 mm); the component D is a depth gauge.

After drilling of a cut hole with different drills B, C, E, F, G and H, a countersink drill, referenced by I, is used to drill the cut hole to the desired diameter equal to the implant K, and then the tap, referenced by J, is used to tap a thread in the cut hole for the installation of the threaded implant K in the crestal cone 10.

According to the aforesaid conventional cut hole drilling method, different sizes of drills must be used, prolonging the operation time and increasing the difficulty, thereby lowering the operation success rate.

### SUMMARY OF THE INVENTION

The present invention has been accomplished under the circumstances in view. It is therefore the main object of the present invention to provide a drill for rapid dental implant, which shortens the operation time, saving tool component changing time, eliminating potential error, and raising the implant success rate.

To achieve this and other objects of the present invention, the drill comprises a connection head configured for quick connection to a dental handpiece, a round bur, and a series of active drill body portions of different diameters connected between the connection head and the round bur, said active drill body portions in an order from the smallest diameter to the largest diameter in direction from the round bur toward the connection head.

Further, a V-groove is formed around the periphery of the drill between each two adjacent ones of the active drill body portions so that the center point is relatively shifted to produce the accurate hole location during drilling.

### BRIEF DESCRIPTION OF THE DRAWINGS

FIG. 1 illustrates a drill set required for cut-hole drilling for dental implant.

FIG. 2 is an elevational view of a drill in accordance with the present invention.

FIG. 3 is a plain view of the drill in accordance with the present invention.

### DETAILED DESCRIPTION OF THE PREFERRED EMBODIMENT

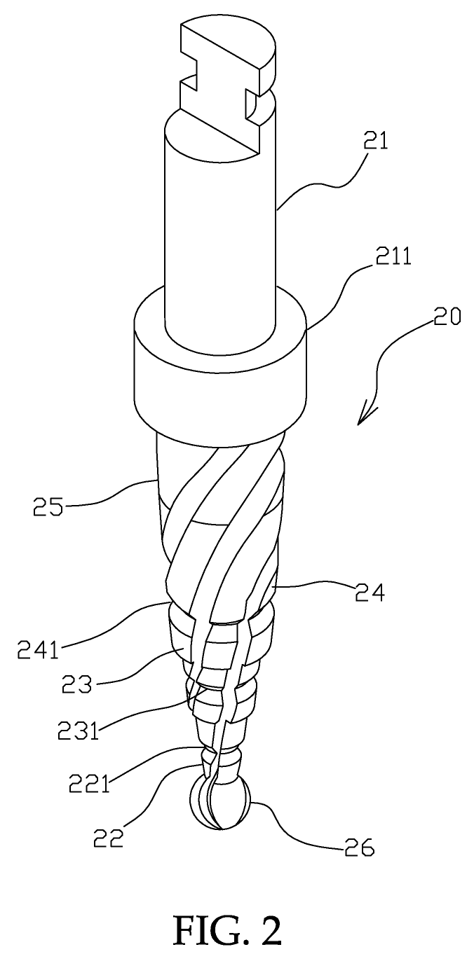

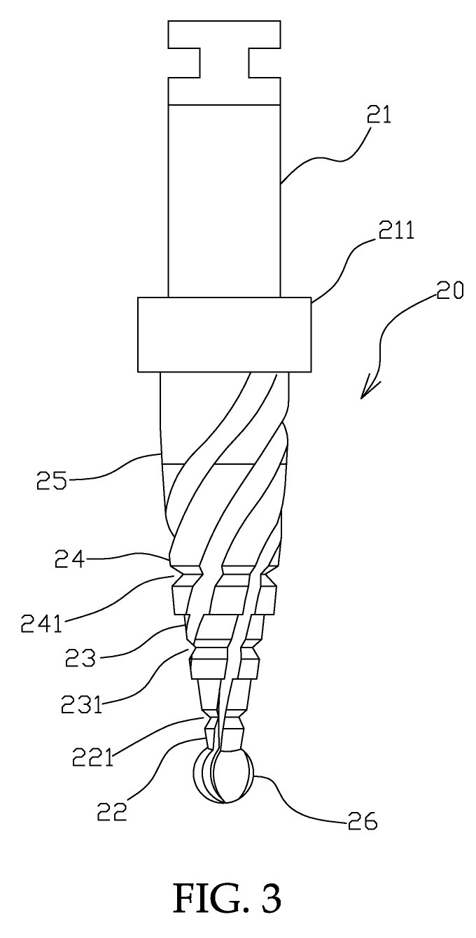

Referring to FIGS. 2 and 3, a drill 20 in accordance with the present invention is shown comprising a connection head 21 configured for quick connection to a dental handpiece, a stop block 211 disposed at the bottom side of the connection head 21, a round bur 26 disposed at the distal end, and a series of active drill body portions 22˜25 axially extending upwards from the round bur 26 to the bottom side of the stop block 211 in axial alignment with the connection head 21 in the order from the smallest diameter to the largest diameter in the direction from the round bur 26 toward the connection head 21. The round bur 26 is for location marking and crestal bone flattening. The active drill body portions 22˜25 are for drilling a vertical hole on the crown.

The active drill body portions 22˜24 show a conical configuration. A V-groove 221, 231 or 241 is provided around the periphery of the drill 20 between each two adjacent ones of the active drill body portions 22˜24 so that the center point is relatively shifted to produce the accurate hole location during drilling. The topmost active drill body portion 25 has a cylindrical shape of uniform diameter. Among the active drill body portions 22˜24, the topmost active drill body portion 25 has the largest diameter and length for drilling a hole sufficient for the insertion of a tap J.

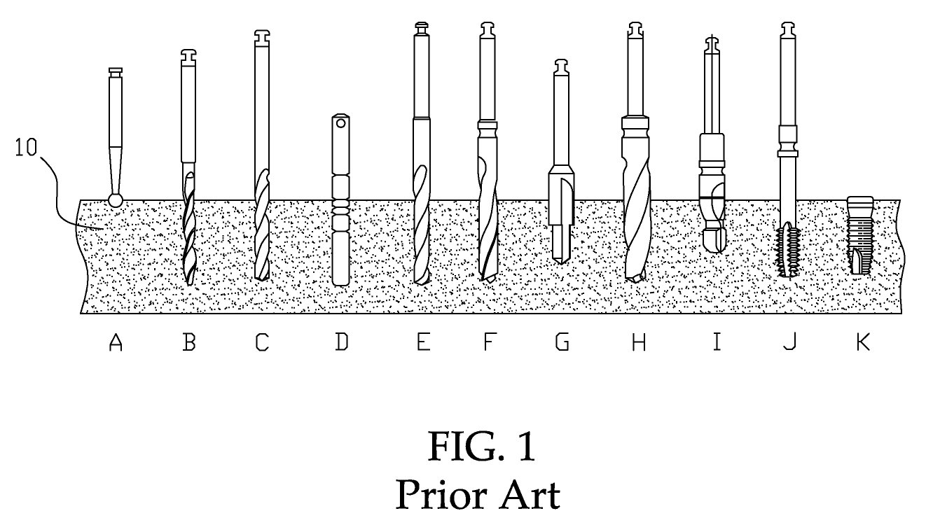

The diameter of the topmost active drill body portion 25 is equal to the diameter of a tap J so that the drill 20 can drill a cut hole equal to the diameter of the implant K to be implanted for tapping with a tap J for the installation of the implant K (with respect to implant K and tap J, please refer also to FIG. 1).

During osteotomy, a cut hole is made on the crestal bone 10 with the drill 20, and then tapped with a tap for directly installation of the implant K. By means of the application of the drill 20, the operation time is greatly shortened, saving tool component changing time, eliminating potential error, and raising the implant success rate.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A drill for dental implant, comprising
a connection head configured for quick connection to a dental handpiece;
a round bur; and
a series of active drill body portions connected between said connection head and said round bur, said active drill body portions having different diameters and being arranged from the smallest diameter to the largest diameter in direction from said round bur toward said connection head.

2. The drill as claimed in claim 1, wherein the topmost active drill body portion that is connected to said connection head has a cylindrical shape, and the other said active drill body portions have a conical shape.

3. The drill as claimed in claim 1, further comprising a plurality of V-grooves extending around the periphery thereof between each two adjacent ones of said active drill body portions.

4. The drill as claimed in claim 2, wherein the topmost active drill body portion connected to said connection head has a length greater than the other said active drill body portions.

5. The drill as claimed in claim 1, further comprising a stop block connected between said connection head and the topmost active drill body portion connected to said connection head.
